(19) United States
(12) Patent Application Publication
(10) Pub. No.: US 2009/0192944 A1
(43) Pub. Date: Jul. 30, 2009

(54) SYMMETRIC VERIFICATION OF WEB SITES AND CLIENT DEVICES

(76) Inventors: George Sidman, Carmel, CA (US); Neal Smith, Monterey, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/358,028

(22) Filed: Jan. 22, 2009

Related U.S. Application Data
(60) Provisional application No. 61/023,413, filed on Jan. 24, 2008.

(51) Int. Cl. H04L 9/32

(52) U.S. Cl. 705/75; 705/27

(57) ABSTRACT

A method and apparatus for symmetric verification of a client device and a web site are described. In one embodiment, the method comprises receiving an identity verification request for an electronic transaction between a client device and a website. In one embodiment, the method may also comprise verifying an identity of both a user associated with the client device and the web site using symmetric verification, and transmitting verification results to the web site and the client device.

### PRIORITY

This application claims the benefit of priority to U.S. Provisional Patent Application Ser. No. 61,023,413, entitled “SYMETRIC VERIFICATION OF WEBSITES AND CUSTOMERS,” filed on Jan. 24, 2008, which is incorporated herein by reference in its entirety.

### FIELD OF THE INVENTION

The present invention relates to the field of Internet communications; more particularly, the present invention relates to security and/or privacy of Internet communications between a website and a client device.

### BACKGROUND OF THE INVENTION

The Internet is a worldwide, publicly accessible series of interconnected computer networks that transmit data by packet switching using the standard Internet Protocol (IP). It is a “network of networks” that consists of millions of smaller domestic, academic, business, and government networks, which together carry various information and services, such as electronic mail, online chat, file transfer, and the interlinked web pages and other resources of the World Wide Web (WWW).

The Internet has introduced various problems regarding the privacy and security of communications transactions occurring over the Internet. Two areas of concern for the Internet are protecting against “phishing” and protecting against Internet fraud. Internet fraud generally refers to any type of fraud scheme that uses one or more online services—such as chat rooms, e-mail, message boards, or Web sites—to present fraudulent solicitations to prospective victims, to conduct fraudulent transaction, or to transmit the proceeds of fraud to financial institutions or to others connected with the scheme.

Similarly, phishing is an example of social engineering techniques used to fool users. More specifically, phishing is an attempt to criminally and/or fraudulently acquire sensitive information, such as usernames, passwords, and credit card details, by masquerading as a trustworthy entity in electronic communications. Phishing is typically carried out by email or instant messaging, and often directs users to enter details at a website.

Attempts to deal with the growing number of reported phishing and Internet fraud incidents include legislation, user training, public awareness, and technical measures. Among the technical measures are some conventional customer pattern analysis products used by banks and other enterprises. These conventional customer pattern analysis products, however, are limited in their ability to trap or block fraudulent activity to generic behavior, which results in high levels of false positives. These conventional customer pattern analysis products are also easily circumvented.

Without technical measures that provide security and privacy to communication transactions over the Internet, the Internet may not be a safe or legally compliant place for both individuals and businesses.

### SUMMARY OF THE INVENTION

A method and apparatus for symmetric verification of a client device and a web site are described. In one embodiment, the method comprises receiving an identity verification request for an electronic transaction between a client device and a website. In one embodiment, the method may also comprise verifying an identity of both a user associated with the client device and the web site using symmetric verification, and transmitting verification results to the web site and the client device.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a network for implementing symmetric verification of a web site and a client device.

FIG. 2 illustrates one embodiment of a symmetric verification process.

FIG. 3 is a flow diagram of one embodiment of a client-side process for symmetric verification.

FIG. 4 is a flow diagram of one embodiment of a web site-side process for symmetric verification.

FIG. 5 is a flow diagram of one embodiment of a web site-side process for adjusting a transaction based on user ratings.

FIG. 6 is a flow diagram of one embodiment of a process for performing symmetric verification.

FIG. 7 is a block diagram of a computer system that may perform one or more of the operations described herein.

FIG. 8 illustrate an exemplary graphical user interface for one embodiment of symmetric verification.

### DETAILED DESCRIPTION OF THE PRESENT INVENTION

A method, apparatus, and article of manufacture for symmetric verification of a client device and a web site are described. In one embodiment, an identity verification request for an electronic transaction between a client device and a website is received. In one embodiment, the transaction may be an online commercial transaction, banking transaction, clearance request, medical information exchange, etc.

In one embodiment, both an identity of a user associated with the client device and an identity of the web site are verified using symmetric verification. In one embodiment, verification results are transmitted to the web site and the client device. Because symmetric verification results are transmitted, the client device may be verified to the website, and the website verified to the client device. In one embodiment, symmetric verification results are transmitted before the transaction occurs.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, USB Devices and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Online account fraud succeeds largely because there is presently no method to verify the identity and veracity of a web site or a user/client device interacting with the web site. In other words, the web site may not know whether the user is who he claims to be, or the user may not know whether the web site is indeed valid, rather than a phishing web site or other form of spoof.

The embodiments discussed herein describe symmetric verification for any web-based transaction, as well as the presence of the privacy facilities to carry out the verification, such as the private communities and private addresses, for example, the WEBLOQ™ privacy products, available from WEBLOQ™, Inc. of Monterey, Calif., such as VIRTUAL PRIVATE COMMUNITIES™ (VPCs), private email, private email addresses, and LOQAGENTS™. The embodiments described herein utilize private communications channels and VPCs, to securely communicate electronically. Private electronic data exchange is described more fully in U.S. Patent Application Publication U.S. 2008/0294726 A1, entitled “Private Electronic Information Exchange,” filed Apr. 22, 2004.

Unlike the conventional products, the embodiments described herein provide symmetric client device and web site verification, along with a customer rating capability that can be applied to further validate the customer. The customer ratings functionality, as described herein, enables web commerce sites to apply adjustable credit limits and vary customer interaction on the basis of the customer rating. In one embodiment, the ratings functionality may leverage existing online rating systems, such EBAY™, PAYPAL™, credit scoring services, etc., to aggregate a consolidated set of ratings into a single rating, usable by a web commerce site to adjust its credit limit and other user-interaction criteria.

Embodiments described herein may be thought of as a dual channel—one public and one private—token matching technology. The public side is the Secure Socket Layer (SSL) enabled web commerce site, to which a verification server may provide minimal server-side and web page code (e.g., web site verification agent). Secure Sockets Layer is a cryptographic protocol that provides secure communications on the Internet for such things as web browsing, e-mail, Internet faxing, instant messaging and other data transfers. The private side is a private channel to the server verification agent, accessible to both the web site and the customer. An arbiter in the middle is a verification server. The verification services described herein may be a hosted service, provided by WEBLOQ™, Inc., or a licensed enterprise solution that provides customer verification, token matching, and end-point confirmation.

The embodiments described herein verify the identity of both a user and a web site in an online transaction. The embodiments described herein also may validate the identity of the web site behind any link presented in an email or web page to a customer. The embodiments described herein provide a user-transparent confirmation solution that protects strongly against phishing and other Internet fraud. Using the trust model and privacy facilities of WEBLOQ™ VIRTUAL PRIVATE COMMUNITEES™, the embodiments described herein deliver to both the web site and an end user (e.g., user of a client device) a symmetric proof that both entities are actually the entities that they claim to be.

### Exemplary Computer Network

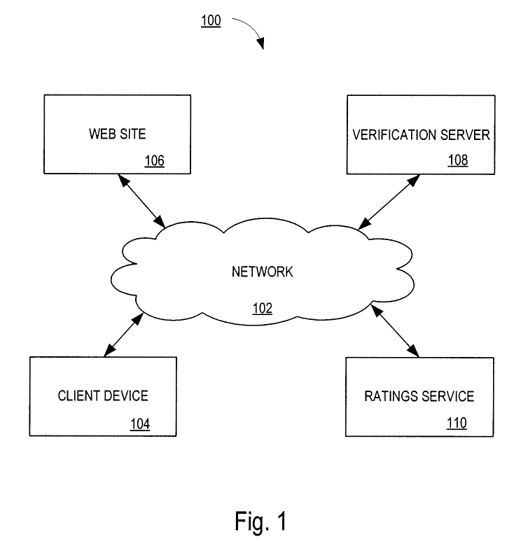

FIG. 1 illustrates one embodiment of network architecture 100 in which embodiments of the present invention may operate. The architecture 100 includes client device 104 coupled to a communications network 102 such as a public network (e.g., the Internet, a wireless network, etc.) a private network (e.g., LAN, Intranet, Virtual Private Community Network, etc.). The web server 106 serves web content, such as a web site, to client device 104 via the network 102. In one embodiment, both the client device 104 and the web site 106 communicate with verification server 108 via the network 102 to enable one embodiment of a symmetric verification mechanism for the client device 104 and web site 106.

In one embodiment, client device 104 is a user-operated system, such as a computer, laptop computer, cellular telephone, personal digital assistant (PDA), etc., and is a subscriber to a security service provided by verification server 108. In one embodiment, client device 104 does not require a particular operating system, network connectivity, or platform. This allows the verification methods, described herein, to enable identity confirmation on any connected client device type. In one embodiment, when client device 104 initially signs up for a new account of the security service provided by verification server 108, client device 104 receives user input that specifies a private phrase identifier. A private identifier may be a private sentence safely stored with additional subscription data, such as, “My Jag is Blue” or “We ADORE Tuscany.” In another embodiment, the private phrase identifier is stored on the verification server 108 in addition to, or instead of, locally at client device 104. In one embodiment, client device 104 runs a client agent that enables token generation and client locking, as discussed in greater detail herein.

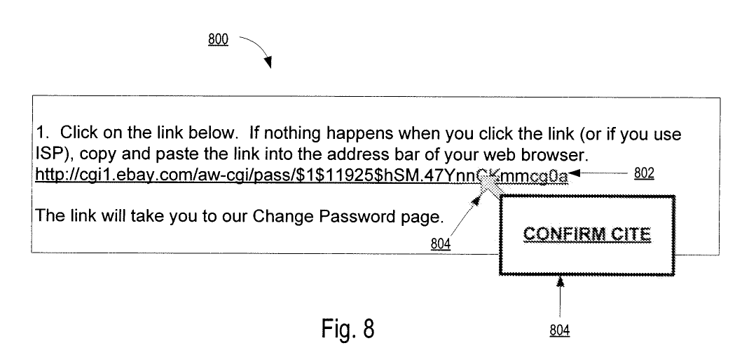

In one embodiment, a verification server agent of the verification server 108 provides a cursor that, on a graphical user interface (GUI) event (e.g., a mouse-over operation) on a link at client device 104, such as a mouse-over of a Uniform Resource Locator (URL), opens a dialog box on a display of client device 104. In one embodiment, the GUI display includes a selection mechanism (e.g., button, URL, etc.) to enable verification of the web site. One embodiment of a selection mechanism is illustrated in web site 800 of FIG. 8. As illustrated, in response to mouse-over 804 at URL 802, selection box 806 is displayed by client device 104. As discussed in greater detail below, user selection of the selection box 806 triggers one embodiment of symmetric verification.

Mouse-over events are particularly common in web browsers where the URL of a hyperlink can be viewed in the status bar. Site designers can define their own GUI events (e.g., mouse-over events) using JavaScript and Cascading Style Sheets (CSS), for example. In one embodiment, a dialog box is displayed at client device 104 to enable user-selection of the dialog to activate the verification process of the link to the web site. In another embodiment, the existence of the GUI event might not be presented on client device 104. Instead, events that impact internal functions of client device 104, automatically initiate a verification process of verification server 108, to allow or deny access to a link based on verification results. In one embodiment, the communications between client device 104 and verification server 108 is managed by a user verification agent residing on the client device 104. In one embodiment, the user verification agent is an extension to LOQAGENT™, available from WEBLOQ™, Inc., which is a local agent on client device 104 that ensures security of electronic mail, messages, other electronic communications, computer software, and services.

In one embodiment, web site 106 serves web sites to client device 104, such as commercial transaction web sites (e.g., AMAZON™, EBAY™, PAYPAL™, etc.), banking web sites, medical information or insurance web sites, etc. Web site 106 is also a subscriber to the security service provided by verification server 108. In one embodiment, upon subscription with verification server 108, verification server 108 provides web site 106 a web site verification agent that may be embedded in web content provided via web site 106. In one embodiment, the verification agent is code, which is embedded in web content served to client device 104. In one embodiment, the web site verification agent enables verification token and consumer ratings management facilities, as discussed in greater detail herein.

In one embodiment, communication between client device 104 and verification server 108 occurs over a private-channel communications network, which is not publicly accessible, while communication between verification server 108 and web site 106 occurs over a secure or insecure public-channel communications network. In another embodiment, both client device 104 and web site 106 communicate with verification server 108 via private-channel communication.

The embodiments described herein provide a symmetric verification mechanism that is easily implemented by subscribers to a privacy service, such as WEBLOQ™ privacy services, overcoming the present lack of any validation services in web commerce today. The web site confirmation returned to the client device 104, and the confirmation of the client device to the web server 106 cannot be spoofed by a fraudster simply because the fraudster cannot qualify to subscribe to the validation service or achieve the control over the VPC facilities necessary to intervene in the confirmation process. Note, it is possible for the fraudster to imitate the on-screen messages returned by the validation service to finalize the confirmation. In one embodiment, it is not possible for the fraudster to imitate the display that is the final confirming step in the process, for example, display of the secret phrase (e.g., “My Jag is Blue” or “We ADORE Tuscany”).

### Verification Service

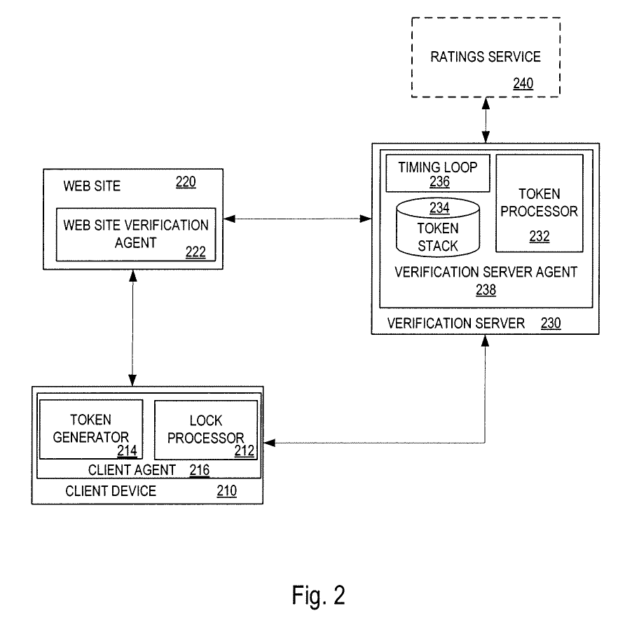

FIG. 2 illustrates one embodiment of a symmetric verification process. In one embodiment, client device 210 browses web site 220. The web site 220 may be a commercial transaction web site, banking web site, medical communications web site, etc.

In one embodiment, by mousing over any URL at client device 210, the referenced web site may be confirmed as an enabled site (e.g., subscriber to the verification service) and therefore valid by verification server 230. Alternatively, the referenced web site may not be confirmed.

In one embodiment, for example, at checkout during online transactions, the web site may be confirmed without a mouse-over operation. In one embodiment, web site 220 includes a web site verification agent 222, which has been provided by verification server 230, as discussed above. In one embodiment, the web site verification agent 222 includes embedded Asynchronous JavaScript and XML (AJAX) code for managing the verification processes discussed herein.

In one embodiment, when a transaction between web site 220 and client device 210 is initiated, web site verification agent 222 calls client agent 216, to automatically launch a symmetric verification process, which attempts to confirm the web site as a valid web site and the client device as a valid client device. In one embodiment, responsive to receiving a call from web site verification agent 222, client agent 216 locks client device 210 from transmitting any sensitive user data to web site 222. In one embodiment, client device 210 remains locked until client agent 216 receives verification results from verification server 230.

In one embodiment, in response to client agent 216 locking client device 210, token generator 214 automatically generates two tokens for use in symmetric verification. In one embodiment, the tokens may include verification data, such as user account information and randomly generated alphanumeric sequences. In one embodiment, client agent 216 routes tokens to both the web site verification agent 222 and verification server agent 238. As will be discussed in greater detail below, in response to web site verification agent 222 receiving a token, web site verification agent 222 modifies the token and forwards it to the verification server 230. In one embodiment the token is modified with identification data corresponding to the web site 220. In another embodiment, the token is modified to include a request for user ratings.

In one embodiment, the verification server 230 may include user online credit ratings, account validation, and other ratings with verification results. In one embodiment, these various user ratings are associated with the user's private email address, PAYPAL™ account, EBAY™ account, credit score, government clearance, etc. Services such as PAYPAL™ and EBAY™ provide online ratings to maintain the integrity of their communities, and are readily available to online merchants through EBAY™ and PAYPAL™ provided software development kits (SDKs). Automated lookups of the three commercial credit ratings are also available to qualified merchants. In one embodiment, the verification server 230 provides a secure consumer credit rating back to website 220 concurrent with the token matching process described herein. As a result, web site 220 is able to rate a new user, adjust an existing user's credit limit, etc. Similarly, the web site 220 site may be rated by users, and a user may adjust the web site's credit limit.

Token processor 232 of verification server 230 attempts to match the verification data received in the token, and either confirms each party to the other when tokens are matched, or responds to the web site verification agent 222 and client agent 216 that verification was unsuccessful. In one embodiment, the verification token is unique to each transaction. In one embodiment, verification tokens are routed within a VPC, do not need to be known or shared before hand, do not need to be recorded by the client device, and need not be remembered after the completion of the transaction. The verification token is not required for any other transaction and may be very short lived.

### URL Mouse-Over Token Generation

In one embodiment, upon mouse-over of a URL, a small dialog appears with a selection mechanism, such as a button, to confirm the web site. An exemplary user interface, which illustrates a mouse-over verification dialog box is illustrated in FIG. 8. Upon client device 210 receiving activation of the selection mechanism (e.g., upon a button-click operation), the verification server 230 initiates a dialog between verification server agent 238 and client agent 216. In one embodiment, verification server agent 238 calls the client agent 216 to generate verification tokens.

One embodiment for token generation is discussed in greater detail below, with respect to the consummation of an electronic transaction. The process for symmetric verification utilizing tokens is applicable to mouse-over verification of a URL.

### Transactional Token Generation

In one embodiment, at the consummation of an electronic transaction (e.g., checkout from shopping, submitting banking information, providing personal medical information, etc.), web site verification agent 222 calls client agent 216 to generate verification tokens. In one embodiment, AJAX or other computer code embedded in a website transmits data to client agent 216 to initiate token generation. In one embodiment, in response to client agent 216 receiving a call to initiate token generation, lock processor 212 locks client device 210. In one embodiment, client device 210 is locked form sending any information to web server 220 until lock processor 212 unlocks the client device 210. In one embodiment, client agent is a LOQAGENT™ extension application provided by WEBLOQ™.

In one embodiment, client agent 216 performs a lookup to confirm a customer account with verification server 230 before token verification. Assuming that client device 210 has an account for verification services with verification server 230, token generator 214 generates two tokens, which includes verification data such as user account information and randomly generated alphanumeric data strings. In one embodiment, client agent 216 then attaches a user's private email address (e.g., a user that has subscribed to the verification services for client device 210) to the two verification tokens and transmits the tokens simultaneously to web server 220 and verification server 230 in two separate packets.

In one embodiment, client agent 216 transmits a first packet to the verification server agent 238 at the verification server 230. In one embodiment, the first packet includes the verification token, the customer's private email address, additional header information, or the like. In one embodiment, client agent 216 transmits a second packet to the web site verification agent 222 at the web site 220. In one embodiment, the second packet contains the verification token and the customer's private email address. In one embodiment, the second packet only contains the verification token and the customer's private email address. In one embodiment, when client agent 216 transmits the second packet to web site verification agent 222, client agent 216 is thereafter locked until the verification server 230 matches the first and second packet, to determine whether the web site is confirmed or not.

When verification server 230 receives the first token packet (e.g., the packet transmitted from the client device 210 to the verification server 230), the first packet is authenticated. In one embodiment, the packet is authenticated based on a user name and password accompanying the packet, a device signature (e.g., a signature based on various hardware metrics extracted from a device), account/subscription verification, etc. After the packet is authenticated, the first packet's content are stored in token stack 234, and timing loop 236 is commenced. In one embodiment, the timing loop 236 consists of a timer of a few seconds (e.g., 10-15 seconds) within which the second packet must be received and matched to obtain a successful verification.

In one embodiment, in response to the web site agent 222 receiving the second packet, the web site verification agent 222 caches/stores the second token packet. In one embodiment, web site verification agent 222 modifies the token and then routes the second packet to the verification server 230. In one embodiment, web site verification agent 222 modifies the token by writing identification data for the web site in the token. In one embodiment, an optional request for a customer rating is also written into the token.

In one embodiment, verification server agent 238 of the verification server 230 receives the second packet from the web site and token processor 232 attempts to match the first and second tokens. Upon a successful match, confirmation results are transmitted to web site 220 and client device 210.

In one embodiment, where verification server agent 238 receives a token including a request for user ratings data, token processor 232 requests user ratings data from one or more ratings services, such as ratings service 240. Customer ratings data is appended to the confirmation result prior to transmission to web site 220. In one embodiment, the user ratings data (e.g., EBAY™ ranking, PAYPAL™ ranking, credit score, etc.) enables web site to modify its dealings with the client device on the basis of the customer rating, as described below with respect to the online consumer rating system.

Furthermore, in one embodiment, upon a successful match, verification server agent 238 transmits a confirmation result (e.g., in the form of a packet) sent to client agent 216, including the verification token and the name of the merchant. Upon receipt of this confirmation, the client agent 210 may display the merchant name as being valid, the locally stored private phrase identifier (e.g., “My Jag is Blue”), without which the confirmation cannot be valid. It should be noted that this mechanism cannot be spoofed by a fraudster because the uniquely private phrase identifier cannot be discovered online, extracted from client agent 216, or easily guessed. In one embodiment, upon verification results being received by client agent 216, lock processor 212 unlocks the client device (i.e., client device 210 is free to transmit sensitive information, such as credit card information, social security information, bank account numbers, etc.) to web site 220. In one embodiment, client device 210 does not provide user controls over lock activities, unless allowed by the merchant site.

In one embodiment, where token processor 232 does not match the client and web site tokens, or the timing loop fails with no match, verification server agent 238 transmits a match failure message to both client device 210 and web site 220. In one embodiment, a match failure occurs when one side of the token pair is a fraud, or an account lookup for account verification returns a problem with the account, requiring special handling. In one embodiment, client agent 216 may display a warning message to a user of the client device (e.g., “No Match”). In one embodiment, the verification failure message unlocks client device 210. In one embodiment, a verification failure does not prevent web site 220 and client device 210 from exchanging sensitive information.

In one embodiment, upon a successful or unsuccessful match, token processor 232 expires the tokens stored on server 230. By expiring the tokens, they may not be used again for a period of time, thereby decreasing the risk of possible fraudulent behavior.

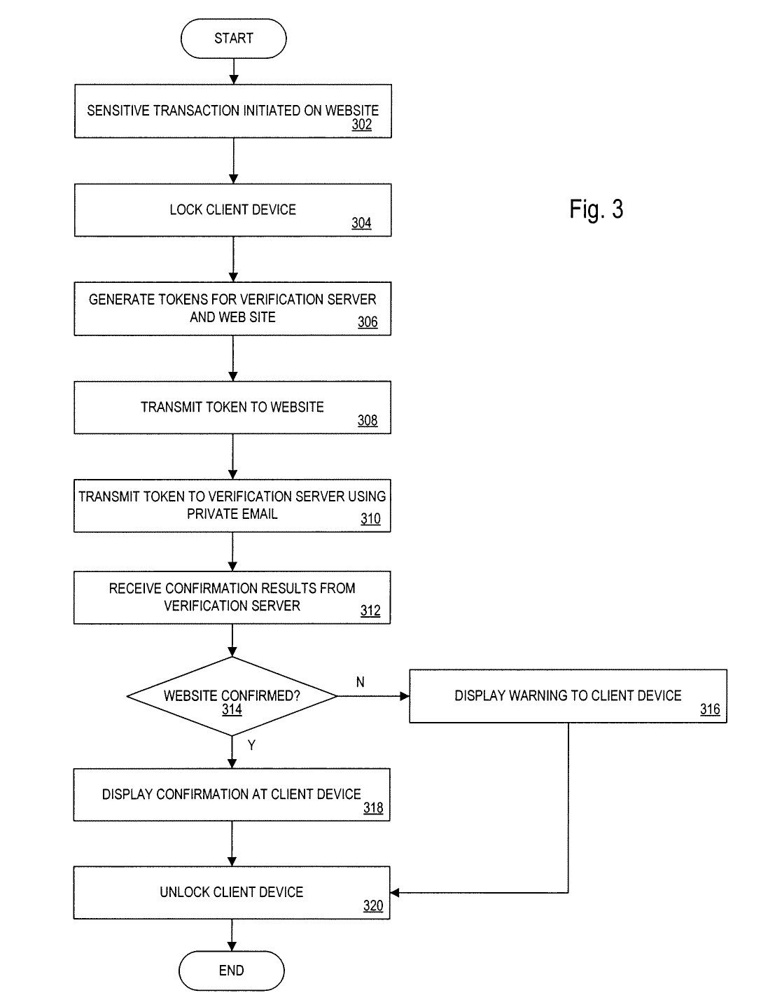

FIG. 3 is a flow diagram of one embodiment of a process for a symmetric verification. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in client agent 216 of FIG. 2.

Referring to FIG. 3, the process begins with processing logic receiving data indicating that a sensitive transaction has been initiated (processing block 302). In one embodiment, the transaction is a transaction between a web browser of client device (e.g., a computer, smart phone, PDA, etc.) and a web site. In one embodiment, the transaction may be “sensitive” because it involves a client device transmitting private information, such as credit card numbers, bank account numbers, medical records, etc.

Processing logic locks a client device from sending any additional data to the website (processing block 304). In one embodiment, processing logic locks the client device based on web site code embedded within the website on which the transaction is occurring. In one embodiment, AJAX code locks the client.

Processing logic generates tokens for transmission to a verification server and web site (processing block 306). In one embodiment, the tokens are extensible markup language (XML) or other data format files, which include a client's private identity, username, password, verification service subscription data, verification data, etc. In one embodiment, a token is written in a standardized universal XML file which includes data fields for use by each component of a symmetric verification system. For example, the XML file includes locations for storing tokens, client data, web site data, verification server confirmation results, and user ratings information. By utilizing a universal token, data transmission is simplified since each entity receive the same type of packet.

Processing logic transmits a first token to the web site (processing block 308), and transmits a second token to a verification server using private email (processing block 310). As described herein, private email ensures the contents of an electronic communication may not be tampered with by outside parties since the email is not routed on a publicly accessible network. In one embodiment, the tokens are transmitted to the web site and verification server simultaneously.

Processing logic receives confirmation results from the verification server (processing block 312) and a determination as to whether the web site was confirmed is made (processing block 314). When a web site has not been confirmed, a warning message is displayed on the client device (processing block 316). When a website is confirmed, a verification success message is displayed on the client device (processing block 318). In one embodiment, the verification success message displayed includes a private sentence locally stored at the client device and/or the name of the web site.

Processing logic then unlocks the client device (processing block 320). In one embodiment, the client device is unlocked (e.g., it is enabled to transmit information to a web site) when web site verification is both successful and unsuccessful. By displaying a warning message at processing block 316, a user is able to proceed knowing that they are dealing with an unverified web site. However, the transaction may still proceed.

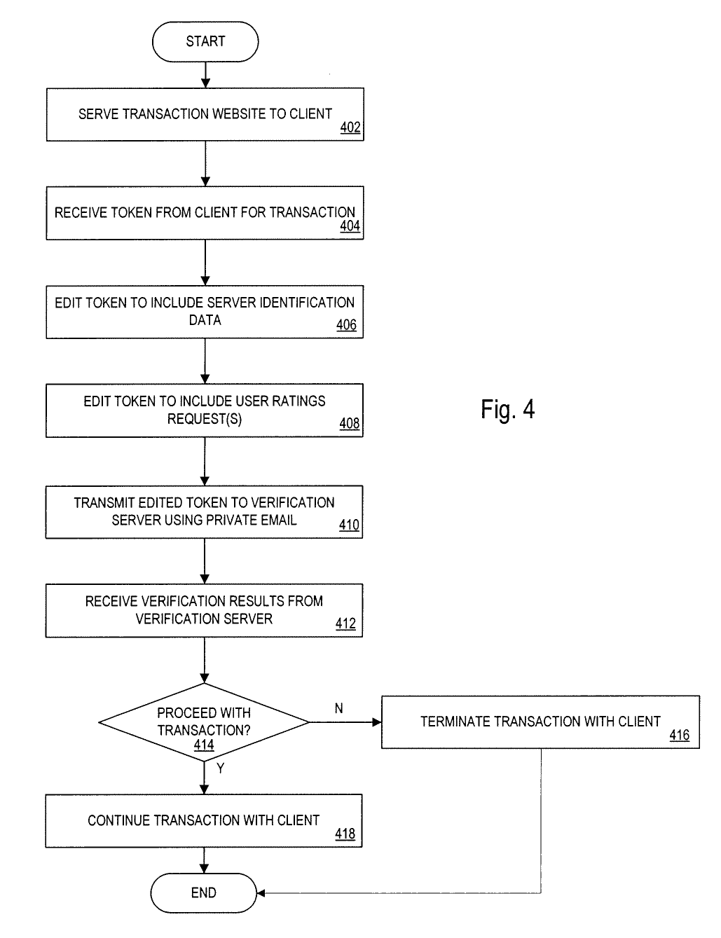

FIG. 4 is a flow diagram of one embodiment of a process for a symmetric verification. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in web site verification agent 222 of FIG. 2.

Referring to 4, the process begins with processing logic serving a transactional web site to a client device (processing block 402). In one embodiment, the transactional website is a website for electronic commerce, internet banking, medical information exchange, government communication, etc. In one embodiment, the web site includes embedded code for managing verification activities, such as triggering a lock on a client device.

Processing logic receives a token from a client device for the transaction (processing block 404) and edits the token to include web site identification data (processing block 406). In one embodiment, processing logic writes server identification data to a reserved data field within the token, such as an XML document field. Processing logic further, in one embodiment, edits the token to include user ratings requests (Processing block 408). In one embodiment, the user ratings requests may request information such as, EBAY™ reliability ratings, PAYPAL™ account ratings, a user credit score, security clearance, etc. for a user associated with the client device.

Processing logic transmits the edited token to the verification server (processing block 410) and corresponding verification results are received from the verification server (processing block 412). In one embodiment, the verification results indicate verification success or failure, whether a verification attempt has timed out, etc.

Processing logic then determines whether to proceed with the transaction based on the verification results (processing block 414). When processing logic determines, based on verification results, not to continue a transaction (e.g., complete a sale, provide bank account information, etc.), the transaction is terminated and a corresponding message is transmitted to the client device (processing block 416). However, when verification is successful, processing logic contuse the transaction with the client device (processing block 418).

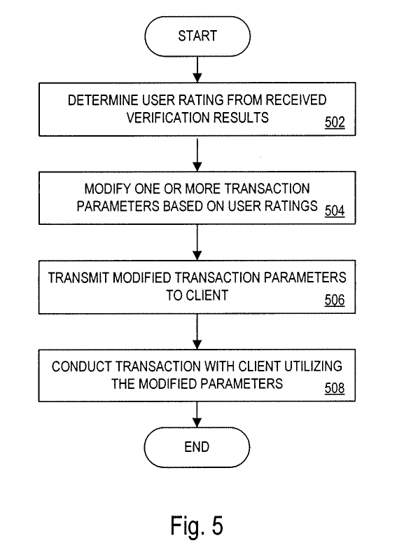

FIG. 5 is a flow diagram of one embodiment of a process for adjusting a transaction based on user ratings. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in web site verification agent 222 of FIG. 2.

Referring to FIG. 5, the process begins with processing logic determining a user rating from received verification results (processing block 502). In one embodiment, the user ratings include a user's EBAY™ rankings, credit score, etc. In another embodiment, the user rating is an aggregate score based on multiple ratings.

Based on the receive user rankings, processing logic modifies one or more transaction parameters (processing block 504). In one embodiment, the parameters indicate that although a user has been verified, the transaction should not proceed because the user's ratings are too low. In another embodiment, user ratings indicate that a transaction's favorability rating be increased. For example, if a user is shopping online at MACYS™, and applies for a credit card, user ratings results might indicate that the user is eligible for a $1000 credit limit instead of the typical $500 limit.

Processing logic transmits the modified transaction parameters to a client device (processing block 506) and the transaction is conducted with the client utilizing the modified parameters (processing block 508).

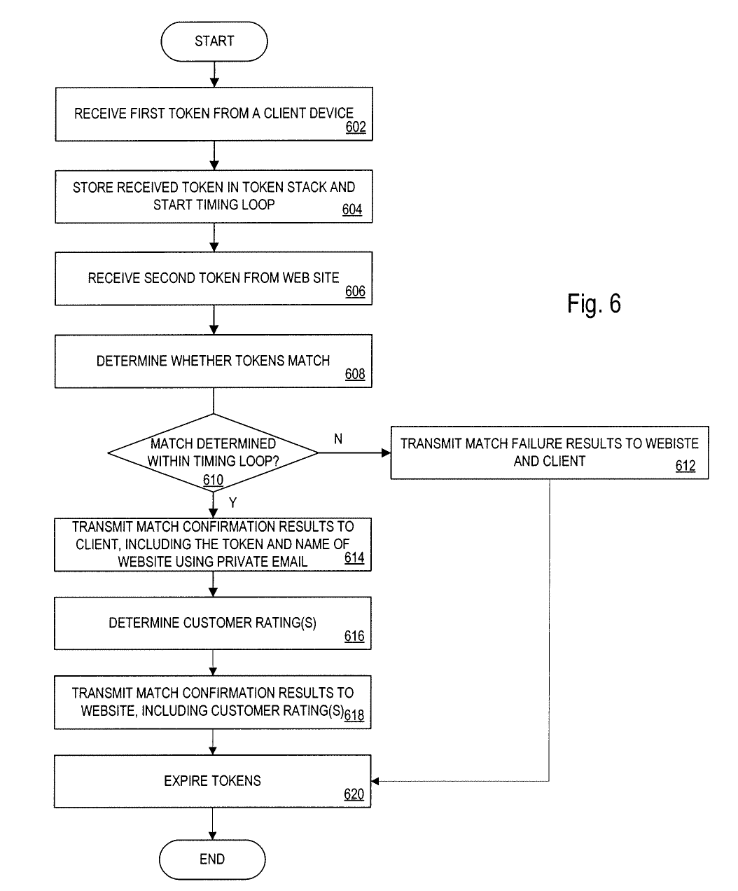

FIG. 6 is a flow diagram of one embodiment of a process for performing symmetric verification. The process may be performed by processing logic that may comprise hardware (e.g., dedicated logic, programmable logic, microcode, etc.), software (such as run on a general purpose computer system or a dedicated machine), or a combination of both. In one embodiment, processing logic resides in verification server agent 238 of FIG. 2.

Referring to 6, the process begins with processing logic receiving a first token from a client device (processing block 602). In one embodiment, processing logic stores the received token in a token stack and starts a timing loop (processing block 604).

Processing logic receives a second token from a web site (processing block 606), and then attempts to match the two tokens (processing block 610). When the tokens are not matched within the time set by the timing loop (processing block 610), processing logic transmits a match failure result to the web site and client to the transaction. Processing logic then expires the tokens (processing block 620).

When the tokens are matched within the timing loop (processing block 610), a verification result confirming the match is transmitted to the client, including the token and name of the website using private email (processing block 614).

Processing logic obtains one or more user ratings for a user associated with the client device (processing block 616). In one embodiment, the user ratings are obtained from web based services, such as EBAY™ and PAYPAL™, utilizing applications provided by those services. The user ratings may also be obtained from credit ratings agencies, security clearance agencies, etc.

The match confirmation, including customer ratings, is transmitted to the website (processing block 618). In one embodiment, the customer ratings are transmitted to the web site as discrete and separate ratings. In another embodiment, an aggregate rating is determined by processing logic and transmitted to the web site (processing block 618).

Processing logic then expires the tokens (processing block 620). By expiring the tokens, processing logic ensures that they may not be used in subsequent transactions, or, if discovered by an un-authorized party, used to intervene and divert the transaction.

### Defenses Against Attack

There is very little about a web site that cannot be spoofed onto a counterfeit site, including a look-alike to almost all the functionality of the verification capabilities. The systems and methods for symmetric verification described herein have been designed with the presumption that a fraudster will request and will get private email addresses and perhaps even tokens, and will attempt to convince a user/client device that all is well. However, the counterfeit site will not be able to have any relationship with the verification server. The counterfeit site is precluded by the short duration of fraudster sites, (typically on average approximately 4 days) and the waiting period (approximately 30 days) required to qualify as a valid verification web commerce site. Moreover, the triggered display of the unique, private phrase identifier (e.g., “My Jag is Blue”), which occurs on a token match at a client device, cannot be imitated by a fraudster without physical control of the end-user device.

The possible attacks to the methods and systems described above would be attempts to imitate the dialogs and messages that the verification server delivers to client devices and web sites. Although a fraudster possibly could imitate a GUI cursor (e.g., FIG. 8), the fraudster cannot imitate the remainder of the process because the fraudster has no relationship with the verification server. The fraudster could also possibly imitate the web commerce site and the token transfer, along with phony messages back to the customer that the site is valid, but cannot imitate the display of the private phrase identifier because he cannot know it, and it is not transmitted across the Internet or made persistent anywhere other than the end-user device.

The fraudster cannot mask the URL address of a phishing site (even a rock phishing site) to defeat a URL lookup. Rock phishing is often used to refer to phishing attacks with some particular features. To minimize the effects of takedown, rock phishers often update DNS records over the course of the phishing attack. Moreover, sequential spam batches often use different and unrelated URLs. In the extreme, it would be possible for phishers to use a given URL only on one particular spoofed email, sent to only one potential victim. Another distinguishing aspect of rock phishing is the use of images of text instead of text—this complicates spam filtering, given that optical character recognition (OCR) is fairly slow, and seldom used in spam filters. The mouse-over verification cannot be spoofed or defeated because it only works effectively through the extension to the client and server agents, and if poisoned (redirected to an unauthorized URL), the message back cannot penetrate the client agent extension to spoof the presentation of the private phrase.

Furthermore, the fraudster cannot successfully attack the web commerce site because the fraudster has no way of controlling or spoofing the token matching process. If the fraudster were to append pages to a valid web site, and attempt to imitate the token matching process, the transaction would fail because the spoof would be unable to coordinate the client verification agent side of the token process. Even if he successfully hijacked the token generation process, and somehow sent a token to either/or the web site and verification server, the fraudster cannot spoof the returned messages through the private phrase identifier display.

The history of phishing and other fraud has illustrated that the slightest impediment to a standard fraud process sends the fraudsters after other lower-hanging fruit. Fraud attacks aside, the verification method, as described in the embodiments herein, delivers complete assurance to both client device and website (e.g., buyer and seller, bank and customer, etc.) that the parties at either end are legitimate and their identities have not been compromised.

### Virtual Private Communities

In one embodiment, the verification system and processes described above utilize a robust central database that manages and routes all private email through user-defined Virtual Private Communities—recording all email activity for Sarbanes-Oxley Act (SOX), Health Insurance Portability and Accountability Act (HIPAA) and electronic discovery (E-Discovery) compliance forensics—and delivering detailed output for business intelligence reporting. In one embodiment, the verification token matching is an extension of these database facilities.

### Adaptable Multi-Tier Encryption

In one embodiment, encryption within the verification server may be provided, for example, by a CRYPTOBANK™ facility, that allows the use of any cryptographic algorithm, type, or bit depth. The multi-tier encryption crosses all elements of the email including the header, payload and attachments, and provides protection for all components of the verification token matching service.

Only the sender and recipient can view emails, as transparent key management renders all addresses, content and attachments un-decryptable while in transit. This protects not only the content, but the email addresses as well from harvesting and the related fraud.

### An Example of a Computer System

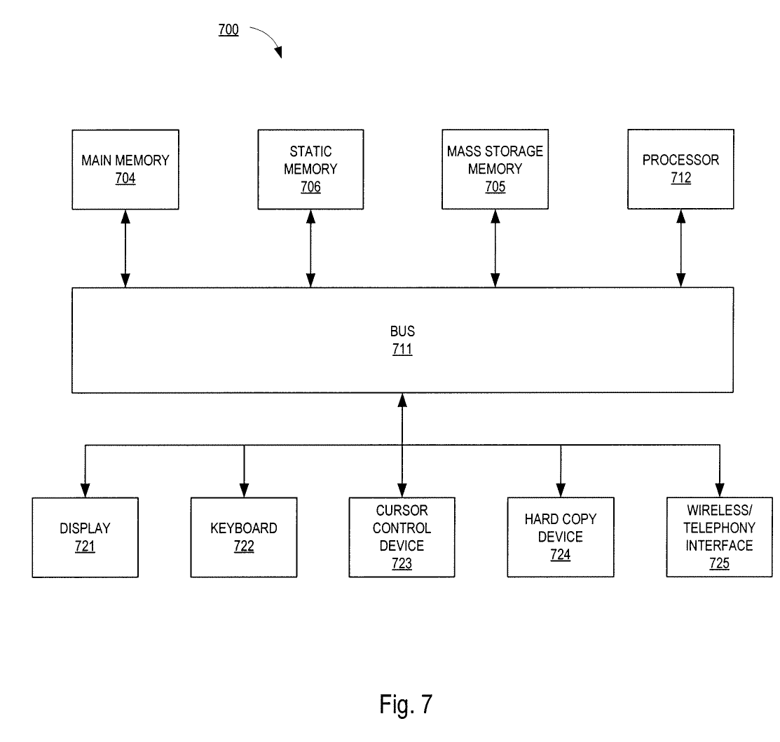

FIG. 7 is a block diagram of a computer system that may perform one or more of the operations described herein. Referring to FIG. 7, computer system 700 may comprise an exemplary client or a server computer system. Computer system 700 comprises a communication mechanism or bus 711 for communicating information, and a processor 712 coupled with bus 711 for processing information. Processor 712 includes a microprocessor, but is not limited to a microprocessor, such as, for example, Pentium™, etc.

System 700 further comprises a random access memory (RAM), or other dynamic storage device 704 (referred to as main memory) coupled to bus 711 for storing information and instructions to be executed by processor 712. Main memory 704 also may be used for storing temporary variables or other intermediate information during execution of instructions by processor 712.

Computer system 700 also comprises a read only memory (ROM) and/or other static storage device 706 coupled to bus 711 for storing static information and instructions for processor 712, and a data storage device 707, such as a magnetic disk or optical disk and its corresponding disk drive. Data storage device 707 is coupled to bus 711 for storing information and instructions.

Computer system 700 may further be coupled to a display device 721, such as a cathode ray tube (CRT) or liquid crystal display (LCD), coupled to bus 711 for displaying information to a computer user. An alphanumeric input device 722, including alphanumeric and other keys, may also be coupled to bus 711 for communicating information and command selections to processor 712. An additional user input device is cursor control 723, such as a mouse, trackball, trackpad, stylus, or cursor direction keys, coupled to bus 711 for communicating direction information and command selections to processor 712, and for controlling cursor movement on display 721.

Another device that may be coupled to bus 711 is hard copy device 724, which may be used for printing instructions, data, or other information on a medium such as paper, film, or similar types of media. Furthermore, a sound recording and playback device, such as a speaker and/or microphone may optionally be coupled to bus 711 for audio interfacing with computer system 700. Another device that may be coupled to bus 711 is a wired/wireless communication capability 725 to communication to a phone or handheld palm device.

Note that any or all of the components of system 700 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method, comprising:
receiving an identity verification request for an electronic transaction between a client device and a website;
verifying an identity of both a user associated with the client device and the web site using symmetric verification; and
transmitting verification results to the web site and the client device.

2. The method of claim 1, wherein the identity of the user and website are verified before the transaction occurs.

3. The method of claim 1, wherein a first verification result corresponding to the user's identity is transmitted to the web site, and a second verification result corresponding to the web site's identity is transmitted to the client device.

4. The method of claim 3, further comprising:
locking the client device used by the user for the electronic transaction during verification, and transmission of the second verification result to the client device to unlock the client device.

5. The method of claim 1, wherein receiving the identity verification request further comprises:
receiving a first token from the client device for the transaction;
receiving a second token from the web site for the transaction; and
matching the first and second token to verify the identity of the user and the web site for the transaction.

6. The method of claim 5, wherein the first token is received via private-channel email from the client device, the second token is received via private-channel email from the web site, the first and second tokens transmitted over an electronic network with a private routing address for routing the private-channel email within a private domain, and wherein the electronic transaction between the client device and the website occurs over a public-channel communications link.

7. The method of claim 5, wherein the second token further includes data to identify the website.

8. The method of claim 5, further comprising:
starting a timing loop when the first token is received; and
transmitting a warning to both the user and the website when the first and second token are not matched before the expiration of the timing loop.

9. The method of claim 5, wherein receiving a second token further comprises:
receiving a request to obtain user ratings for the user;
requesting user ratings data for the user from at least one ratings service provider system; and
transmitting the user ratings data for the user to the website.

10. The method of claim 9, wherein the at least one ratings service provider system, from which user ratings data is requested, are selected from a group consisting of an electronic auction system, an online financial transaction processing system, and a credit reporting system.

11. The method of claim 10, wherein the user ratings are to enable the web site to modify one or more parameters for the transaction between the web site and the user.

12. The method of claim 1, wherein the receiving of an identity verification request is received in response to a user mouse-over selection of a universal resource locator (URL) at the website.

13. A computer readable medium with instructions stored thereon, which when executed by a computer system, causes the computer system to perform a method comprising:
receiving an identity verification request for an electronic transaction between a client device and a website;
verifying an identity of both a user associated with the client device and the web site using symmetric verification; and
transmitting verification results to the web site and the client device.

14. The computer readable medium of claim 13, wherein the identity of the user and website are verified before the transaction occurs.

15. The computer readable medium of claim 13, wherein a first verification result corresponding to the user's identity is transmitted to the web site, and a second verification result corresponding to the web site's identity is transmitted to the client device.

16. The computer readable medium of claim 15, further comprising:
locking the client device used by the user for the electronic transaction during verification, and transmission of the second verification result to the client device is to unlock the client device.

17. The computer readable medium of claim 13, wherein receiving the identity verification request further comprises:
receiving a first token from the client device for the transaction;
receiving a second token from the web site for the transaction; and
matching the first and second token to verify the identity of the user and the web site for the transaction.

18. The computer readable medium of claim 13, wherein the first token is received via private-channel email from the client device, the second token is received via private-channel email from the web site, the first and second tokens transmitted over an electronic network with a private routing address for routing the private-channel email within a private domain, and wherein the electronic transaction between the client device and the website occurs over a public-channel communications link.

19. A system, comprising:
a memory to store tokens; and
a token processor to, receive an identity verification request for an electronic transaction between a client device and a website, verify an identity of both a user associated with the client device and the web site using symmetric verification, and transmit verification results to the web site and the client device.

20. The system of claim 19, wherein the identity of the user and website are verified before the transaction occurs.
